(19) United States
(12) Patent Application Publication
(10) Pub. No.: US 2003/0136667 A1
(43) Pub. Date: Jul. 24, 2003

(54) Dosing unit with electrically polarised moving member

(76) Inventors: Thomas Graf, Arsley (DK); Henrik Orsnes, Wil (CH); Degn Hans, Odense (DK)

Correspondence Address: James C Wray, Suite 300, 1493 Chain Bridge Road, McLean, VA, 22101, US

(21) Appl. No.: 10/221,937

(22) PCT Filed: Mar. 16, 2001
(86) PCT No.: PCT/EP01/03015

(30) Foreign Application Priority Data
Mar. 18, 2000 (EP) 00105814.8

(51) Int. Cl. G01N 27/26; C25C 7/00; C25B 9/00

(52) U.S. Cl. 204/242; 204/400

(57) ABSTRACT

The dosing unit comprises a moving member which is pressed against a gasket mounted at the circumference of an opening in the wall of a reservoir such that a part of the surface of the moving member is in contact with a liquid inside the reservoir and a part of the surface is in contact with the medium in a compartment outside the reservoir. The gasket ensures that the liquid does not flow from the reservoir to the outside compartment and medium does not flow from the outside compartment to the reservoir except when the moving member is moved and medium adhered to its surface is dragged by the gasket. Due to the invention, an electrode is provided in the reservoir and an electric potential may thereby be established between the moving member and the liquid in the reservoir.

The present invention relates to a dosing unit as described in the descriptive part of claim 1. The invention further relates to use of such a dosing unit.

### DESCRIPTION OF PRIOR ART

A number of dosing units for dosing small amounts or streams of liquid into a system are known, for example as described in international application WO 99/20329 and references therein. The dosing unit as disclosed in application WO 99/20329 is a device for continuous mechanical introduction of liquid sample from a reservoir into a system, preferably a mass spectrometer. A moving member, preferably a ball mounted on a shaft, is placed inside the reservoir and pressed against a polymer gasket situated around a hole leading from the reservoir to the system. By rotation of the moving member sample liquid sticking to the surface of the moving member is dragged past the gasket into the system.

None of these dosing units comprises a moving member which is electrically polarised with respect to the liquid in the dosing unit. Polarisation of the moving member, however, would be a means of modifying the dosing process in useful ways.

### SUMMARY OF THE INVENTION

It is the object of the present invention to provide a dosing unit with a moving member wherein the moving member is electrically polarised with respect to the liquid to be dosed.

According to the present invention, this is achieved by a dosing unit mentioned by way of introduction and as described in the characterising part of claim 1.

The invention is a further development of prior art as disclosed in the above mentioned international patent application WO 99/20329. A moving member, preferably spherical or part of a sphere, is mounted such that it is in contact with the media present in two or more compartments. The compartments are separate, and one or more gaskets around the moving member ensures that medium from one compartment does not flow into another compartment. A compartment may be a reservoir, a sample cell or a system such as a mass spectrometer or an electrochemical cell. Due to the invention an electrode is provided in at least one compartment containing liquid and an electric potential is established between the electrode and the moving member. Rotation of the moving member will cause minute amounts of liquid adhered to the surface of the moving member to be dragged past the gasket into the next compartment in the direction of rotation where it may be released from the surface and enter into the medium present in said compartment. Electric polarisation of the moving member with respect to the liquid will affect the local concentrations of solutes in the liquid layer adjacent to the surface of the moving member so as to influence dosing rates.

The electrode should preferably be made of a material such as noble metal or carbon which are durable in electrochemical cells. The moving member, or at least its surface, should likewise be made of a material suitable for electrochemical use. In addition it should be as resistant as possible to frictional wear against the gasket. Possible materials are gold, platinum, iridium or palladium. The inside material of the moving member can be titanium, glass or polymer with a surface layer of gold, platinum, iridium or palladium. Alternatively, the moving member can be assembled from pieces made of different materials.

The material for the gasket should have low electric conductivity and be inert towards aggressive liquids. A possible material for the gasket is TEFLON.

### BRIEF DESCRIPTION OF THE DRAWINGS

FIG. 1 shows a dosing unit according to the invention attached to a system of unspecified kind,

FIG. 2 shows a dosing unit according to the invention attached to a system which is an electrochemical cell,

FIG. 3 shows a dosing units attached to a system which is also a dosing unit,

FIG. 4 is a mass spectrum of a solution of acetic acid achieved in an experiment using the dosing unit combined with a mass spectrometer but without electric polarisation of the moving member,

FIG. 5 is a schematic mass spectrum of acetic acid taken from a data base of mass spectra,

FIG. 6 is a mass spectrum of a neutral solution of sodium acetate achieved in an experiment using the dosing unit combined with a mass spectrometer but without electric polarisation of the moving member,

FIG. 7 is a mass spectrum of the same solution as in FIG. 6 achieved using the dosing unit combined with a mass spectrometer with electric polarisation of the moving member,

FIG. 8 is a spherical moving member assembled from parts made of different materials including a functional surface made of platinum, and

FIG. 9 is face view and section of a gasket with a flow-through channel for a sample stream.

### DETAILED DESCRIPTION OF THE INVENTION

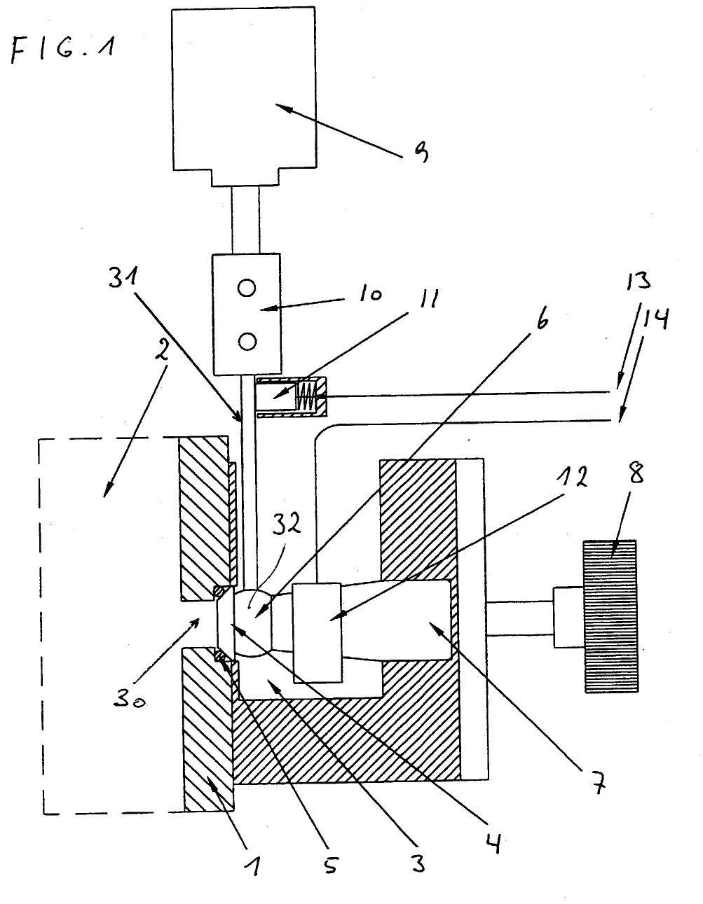

FIG. 1 shows a preferred embodiment of the invention. The dosing unit is mounted on a flange 1 which is attached to an unspecified system 2. A liquid sample reservoir 3 made of non-conducting material, is attached to a flange 1. A gasket 4 resting on a rubber o-ring 5 is placed at the orifice of a hole 30 in the flange 1. A moving member 6, shaped as a ball 32 with a shaft 31, is situated inside the reservoir 3 and pressed against the gasket 4 through an opening in the wall of the sample reservoir 3. Force used to press the spherical part 32 of the moving member 6 against the gasket 4 is delivered by a rod 7. The force is adjustable by means of an adjustment screw 8. The gasket 4 and the rod 7 are both made of TEFLON, polyethylene or other low friction polymer.

The moving member 6 is preferably made of solid platinum or platinum plated material. The shaft of the moving member is attached to a gear motor 9 through an adapter 10 made of a non-conducting material. A piece of coal 11 is pressed against the shaft of the moving member constituting an electric slide contact. An electrode 12, preferably made of platinum, carbon or other non-corroding material is placed inside the reservoir 3. A conventional reference electrode such as a calomel electrode may also be placed in the reservoir 3 to determine the potential of the spherical moving member 6 with respect to the sample liquid. When the spherical moving member 6 is submerged in liquid and it is rotated by the gear motor 9, a minute amount of liquid sample adhering to the surface of the moving member is continuously dragged past the gasket into the system 2 where it may be released by dissolution or evaporation into the medium present in the system. When an electric potential is established between the moving member 6 and the liquid by connecting a voltage supply to the wires 13 and 14, local concentrations of solutes in the liquid adjacent to the surface of the moving member are changed and, as a result, the amounts of solutes dragged from the reservoir 3 into the system 2 by rotation of the moving member are changed. Furthermore, electric polarisation of the moving member may lead to electrochemical transformations of solutes, and reaction products at elevated concentrations at the solid-liquid interface may be transferred into the system rather than being released to the bulk of the liquid sample. No liquid or gas from the reservoir 3 can enter into the system 2 unless the spherical moving member is rotating.

The system 2 to which the dosing unit shown in FIG. 1 is attached is for example a mass spectrometer which periodically records a mass spectrum of the sample stream or continuously monitors selected mass peaks. Effects of polarisation of the moving member during mass spectrometric measurements with the dosing unit on the intensities of mass peaks are demonstrated in the experiments described below.

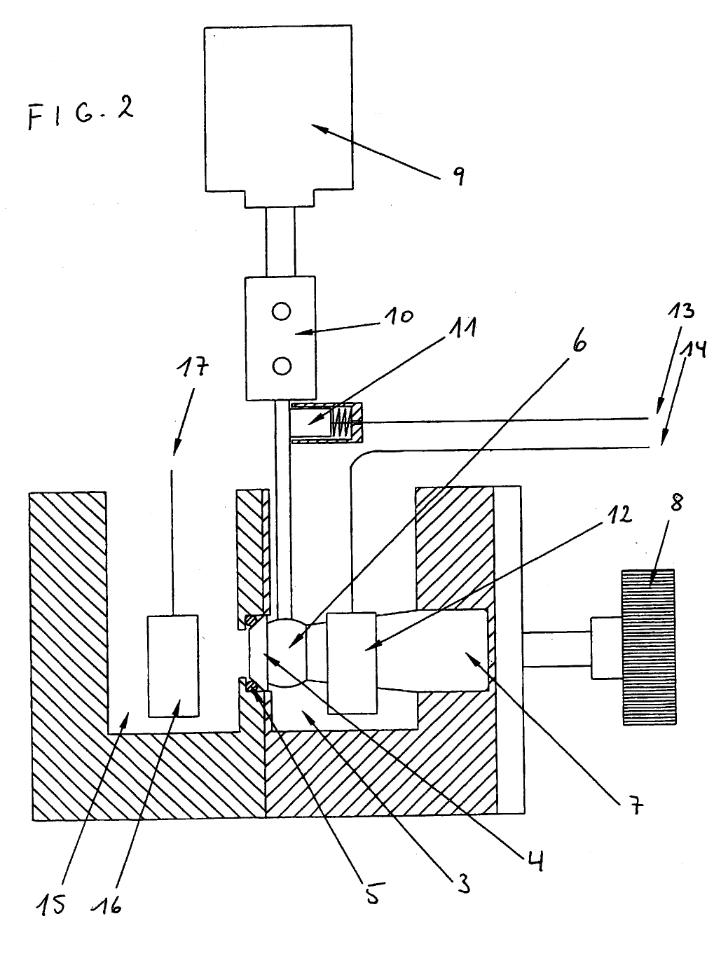

Alternatively the system to which the dosing unit according to the invention is attached may be an electrochemical cell. A possible embodiment of this combination, forming a dual electrochemical cell, is shown in FIG. 2. The flange 1 is replaced with a second reservoir 15 provided with a second electrode 16. Other constructional details are as in FIG. 1. Suitable materials for all parts are the same as specified for the construction in FIG. 1. If the spherical moving member is submerged in liquid sample in both reservoirs, rotation of the moving member causes small amounts of liquid to be dragged from the first reservoir into the second reservoir and at the same time small amounts of liquid are dragged from the second reservoir into the first reservoir. By means of two independent voltage supplies connected to the two electrodes through wires 14 and 15 and commonly to the moving member through wire 13, the spherical moving member may be polarised independently with respect to the liquid in each of the two reservoirs. Both polarisations can be constant, alternating or following any kind of change such as ramping voltages and the like. Conventional reference electrodes may be placed in the two reservoirs to determine the potentials of the spherical moving member with respect to the liquids in the reservoirs.

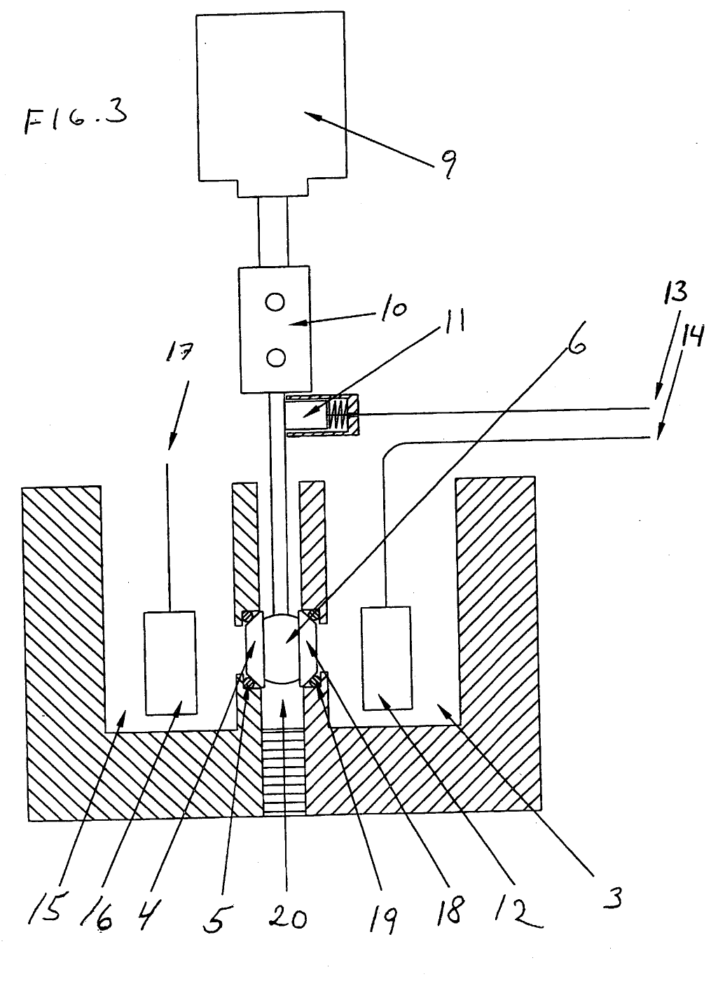

In an alternative embodiment of the invention as a dual electrochemical cell the two reservoirs may be identical, making the device symmetric as shown in FIG. 3. The spherical moving member 6 is clamped between two gaskets 4 and 18 which are resting on two rubber o-rings 5 and 19 mounted in corresponding holes in the walls of two reservoirs 3 and 15. The space 20 between the two identical reservoirs constitutes a third compartment which can be an additional reservoir holding gas or liquid or it can be a system.

By providing independent electric potentials between the liquid and the moving member in the two reservoirs a number of effects can be utilised as apparent from the examples below.

Experiment with Electric Polarisation of Moving Member in Dosing Unit Attached to a Mass Spectrometer

The experiments demonstrate the change of dosing rate of certain solutes from a solution in the reservoir 3 to the system 2, where the system is a mass spectrometer, when the electric potential of the moving member 6 with respect to the solution is changed.

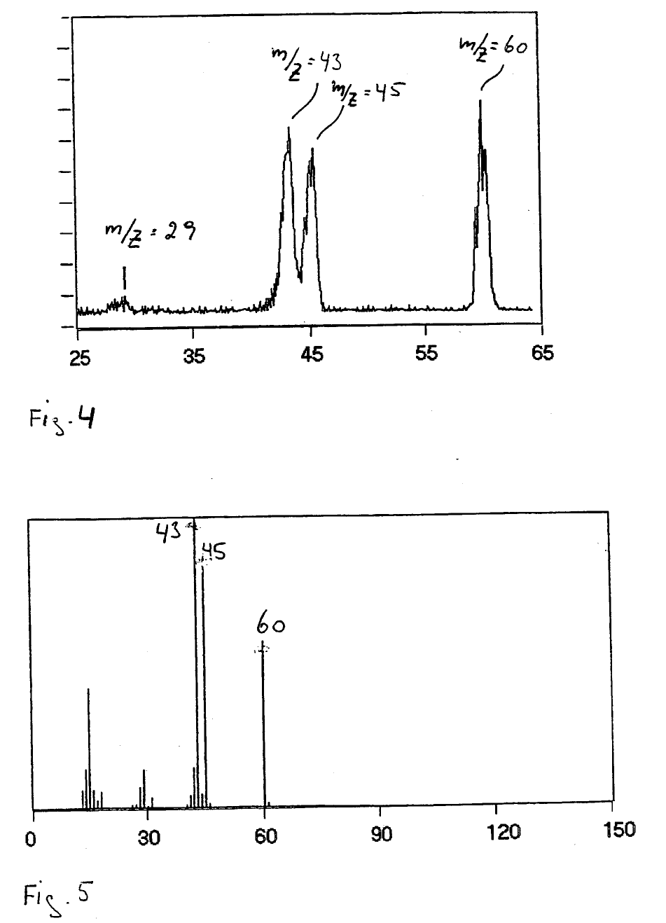

In the experiments the reservoir 3 was filled with an aqueous solution of acetic acid and the system 2 was a quadrupole mass spectrometer with electron impact ionisation. The moving member 6 was made of steel with a platinum surface. FIG. 4 shows the obtained mass spectrum in an experiment where no external voltage was applied to the wires 13 and 14. The horizontal co-ordinate is the molecular mass per charge (m/z) and the vertical co-ordinate is the mass spectrometric ion current in arbitrary units. The major peaks in the spectrum correspond to the m/z values of 43, 45 and 60. These peaks coincide with the peaks of a standard electron impact ionisation spectrum according to prior art as shown in FIG. 5. Due to the comparatively poor resolution of the mass spectrometer employed in the present experiments the smaller peaks seen in the standard spectrum cannot be distinguished in the experimental spectrum. However, from the clearly distinguishable major peaks it is seen that the experimental set-up with out polarisation yields reliable results as compared to prior art.

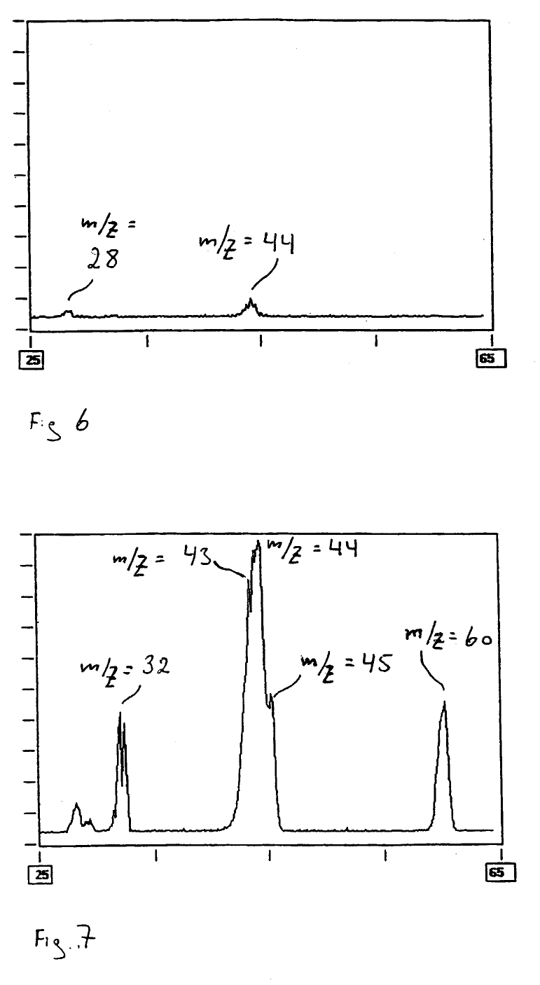

The next step in this experiment was a mass spectrometric measurement without polarisation where the liquid in the reservoir 3 was an aqueous solution of potassium acetate at pH 6.5. No peaks characteristic of acetic acid were found in the spectrum, which is shown in FIG. 6. The peak at m/z 28 is due to N₂ and the peak at 44 is due to CO₂. The explanation why acetic acid is not detected in a neutral solution of acetate is that in such solution acetic acid is dissociated to form acetate ions which do not evaporated from the surface of the moving member when it is exposed to the vacuum of the mass spectrometer.

A second measurement on the same solution, but with the moving member 6 positively polarised with respect to the liquid by the application of an external voltage of 5 volt to the wires 13 and 14, resulted in the mass spectrum shown in FIG. 7 where peaks at m/z 43, 45 and 60 characteristic of acetic acid are evident. Two additional major peaks are seen in the spectrum namely at m/z 32 due to O₂ and at m/z 44 due to CO₂.

It is obvious from the experiment that the positive polarisation of the of the moving member revealed the presence of acetate ions which were not detected without polarisation. A possible explanation of the effect on the mass spectrum of polarisation of the moving member is that the electrolytic decomposition of water at the positively polarised surface of the moving member creates hydrogen ions resulting in a lowering of the pH in the vicinity of the surface. This causes the dissociation of acetic acid to be reversed and the concentration of undissociated acetic near the transporting surface is increased. Hence the rate of transport of acetic acid into the mass spectrometer is increased. The attraction of the negatively charged acetate ions to the positively charged surface of the moving member possibly enhances the effect of polarisation. The peak at m/z 32 which appears as a result of positive polarisation of the moving member is due to O₂ which is produced by electrolytic decomposition of water and the peaked at m/z 44 is due to CO₂ originating from the atmosphere and possibly CO₂ which has been formed by anodic oxidation of acetic acid.

If the moving member had been negatively polarised the decomposition of water would have resulted in an increased concentration of hydroxyl ions and, consequently, an alkaline pH near the surface of the moving member. The change form an acidic to an alkaline pH at the liquid-solid interface by negative polarisation would have the effect of suppressing peaks due to acetic acid. The measurement of many other weak acids would be effected the same way by polarisation as demonstrated for acetic acid. Analogous effects with organic bases would be expected depending on the volatility of the uncharged species.

The effect of polarisation of the moving member demonstrated in the experiment is highly useful because it makes it possible to measure weak acids in neutral solution without acidifying the sample by the addition of a strong acid. Therefore, by using the invention, no destructive treatment of the sample is necessary before the measurement. This is especially important for continuous measurements on badges of reaction mixture or recirculated sample streams. Effects of polarisation as demonstrated in the experiment may also be used for identification of compounds which have peaks at the same m/z-values because different compounds may react differently to polarisation of the moving member.

In addition to measuring compounds present in the sample the dosing unit combined with a mass spectrometer also reveals compounds that are not present in the sample but are created by electrochemical reactions in the dosing unit as a result of the electric polarisation of the moving member. This makes the device useful for the study of electrochemical reactions.

Examples of Possible Uses of the Dosing Unit with an Electrochemical Cell Attached as the System

In a conventional electrochemical cells with two electrodes submerged in an electrolyte the connection of an external voltage supply to the electrodes results in the occurrence of physical and electrochemical processes at the electrolyte-electrode interface and an electric current passes through the cell. Usually the electrode processes associated with the current create such changes at the electrolyte-electrode interface that the current at a constant, externally applied voltage decreases with time. A decreasing current can for example be caused by the deposition of a layer of an electrochemical reaction product on an electrode surface, which makes the surface less active or in extreme cases completely passive. Gradual loss of electrode activity is a serious problem in most technical and analytical electrochemistry and many procedures for reactivating electrodes have been developed. All such procedures, including reversal of potential, treatment with a cleaning reagent or mechanical polishing, require interruption of the operation of the electrochemical cell. The only important electrode with a continuously renewing surface is the dropping mercury electrode whose essential feature is that the electrode material is a liquid that generates fresh surface by the expansion of a suspended drop.

The anodic oxidation of methanol on a platinum electrode is an important example of an electrochemical reaction which is strongly inhibited by intermediates being adsorbed to the electrode surface. The inhibition is an obstacle to creating a direct methanol fuel cell operating at room temperature

In the case where the system attached to the dosing unit according to the present invention is an electrochemical cell as shown in FIG. 2 the resulting device may be operated as a continuously renewing solid electrode. The part of the surface of the moving member which is in contact with electrolyte in the reservoir 15 we shall name the working electrode. When an external voltage is applied to the wires 13 and 17 and the moving member 16 is not rotating a current is passing through the working electrode and the current will decline steadily with time because of gradual inactivation of the working electrode as explained above. When the moving member 6 is made to rotate the partly inactivated surface constituting the working electrode is removed from contact with the electrolyte in the reservoir 15 and replaced by another part of the surface of the moving member which has been exposed to the conditions prevailing in the reservoir 3. If the conditions in the reservoir 3 are designed so as to have a reactivating effect on the surface of the moving member the effect of the rotation of the moving member will be that reactivated surface is continuously supplied at one side of the working electrode while partially inactivated surface is continuously removed at the other side. Under such conditions the current in the working electrode will come to a steady state and not decline steadily with time. Reactivation of the surface during its stay in the reservoir 3 may be effected by a cleaning reagent possibly supplemented by reverse polarisation compared to that in reservoir 16 or polarisation with an alternating voltage or by other suitable means.

In the embodiment of the invention shown in FIG. 2 the rotation of the moving member will drag small amounts of electrolyte from the reservoir 3 into the reservoir 16 and vice versa. This may cause contamination of the electrolyte in one reservoir with electrolyte from the other reservoir adding complications to the electrochemical processes in the two cells. This possibly adverse effect is prevented in the alternative design of the dual electrochemical cell shown in FIG. 3. Here the reservoirs are of identical construction and the device has an additional compartment 20 in the space between the two cells. If this compartment is continuously flushed with pure water the surface of the moving member will be continuously rinsed so that only material which is strongly bound to the surface of the moving member may pass from the reservoir 3 to the reservoir 15 and vice versa by rotation of the moving member. The alternative embodiment shown in FIG. 3 will work as a continuously renewing electrode the same way as explained for the embodiment shown in FIG. 2. Furthermore the compartment 20 may be a system other than a rinsing bath.

We have shown experimentally that the continuously renewing electrode according to the embodiment shown in FIG. 3 is capable of sustained anodic oxidation of methanol at a high current density. In principle it may be utilized in a methanol fuel cell.

Anodic stripping is an electroanalytical technique, where certain metal ions can be measured at low concentrations in water. Metal ions that are dissolved in water are electrochemically reduced and deposited on the surface of an electrode with a negative potential. The deposit accumulated during a prolonged period of time may be released within a short period of time by a reversal of the polarity of the electrode. The release will give rise to a current pulse which depends on the concentration of the ion and the exposure time. The embodiments of the invention shown in FIG. 2 and FIG. 3 can both be operated in an anodic stripping mode, where a deposit is accumulated on the surface of the moving member in one compartment and released by reverse polarisation in the other compartment. A prolonged accumulation phase and a pulsed release phase may be achieved by intermittent rotation of the moving member.

A platinum surface strongly adsorbs molecular hydrogen (H₂). The adsorbed hydrogen may be released into an electrolyte as hydrogen ion (H⁺) by positive polarisation of the platinum. This effect may be utilised to measure the hydrogen content of a gas sample by an embodiment of the invention as shown in FIG. 1 where the compartment 2 is a sample cell or a flow-through cell for gas samples. The part of the surface which is exposed to the gas sample will adsorb hydrogen from the sample and reservoir 3 holds an electrolyte. Rotation of the moving member will transfer the part of the surface to which hydrogen is adsorbed to the reservoir 3 where the hydrogen may be released as hydrogen ion by positive polarisation of the moving member. The electrode current accompanying the release will depend on the partial pressure of hydrogen in the gas sample. The measurement process may be operated by continuous or intermittent rotation of the moving member.

Possible Use of the Dosing Unit in Connection with a Living Organism

The dosing unit can be used in two different ways in connection with a living organism. One where material is dosed from a reservoir into the living organism and one where material is dosed from the living organism into a system such as a measuring apparatus. An example of the first type of application is the use of a dosing unit implanted in a living organism for delivery of a drug. In stead of controlling the rate of delivery by regulating the motion of the moving member one can control the rate of delivery by regulating the electric polarisation of the moving member.

An example of the second type of application is the use of a dosing unit with a flow-through channel in connection with a mass spectrometer to monitor a recirculated blood stream from a patient during heart or lung operation or during blood purification by dialysis. Certain compounds such as weak acids could be made measurable by electric polarisation of the moving member as an alternative to acidifying the blood sample and thus making it unsuitable for recirculation.

Alternative Embodiments

The dosing unit as shown in FIG. 1 is one of several possible embodiments of the invention. In an alternative embodiment the dosing unit has a flow-through channel for a sample stream in stead of a reservoir for a discrete sample. The flow-through channel may be established in a special gasket as shown in FIG. 9 which replaces the ordinary gasket 4 shown in FIG. 1. The special gasket shown in FIG. 9 has a groove 33 in the surface 34 which makes contact with the moving member 6. Pipe stubs 36, to which polymer tubing may be attached, are screwed into holes 35 drilled at the two ends of the groove to make passage for a sample stream through the groove such that the sample stream is in contact with the surface of the moving member. The gasket in FIG. 9 can be made of TEFLON, polyethylene or other low friction polymer. The electrode needed to polarise the moving member with respect to the sample may be a pipe stub 36 made of a suitable material such as platinum or it may be stretch of platinum tube inserted in the polymer tubing used to lead the sample stream through the flow-through cell.

In the embodiments of the invention shown in FIGS. 1-3 the transporting surface of the moving member is spherical. Many alternative shapes of the transporting surface are possible, such as flat or cylindrical, which allows the moving member to slide relative to a gasket without the seal being broken. Reciprocating motion of the moving member may be used as an alternative to rotary motion and motion may be constant or intermittent. The driving force for the motion of the moving member is preferably derived from an electric motor, but other sources of power are possible. For example a dosing unit can be an implant in a living organism and utilise energy from muscle contraction to drive the motion of the moving member.

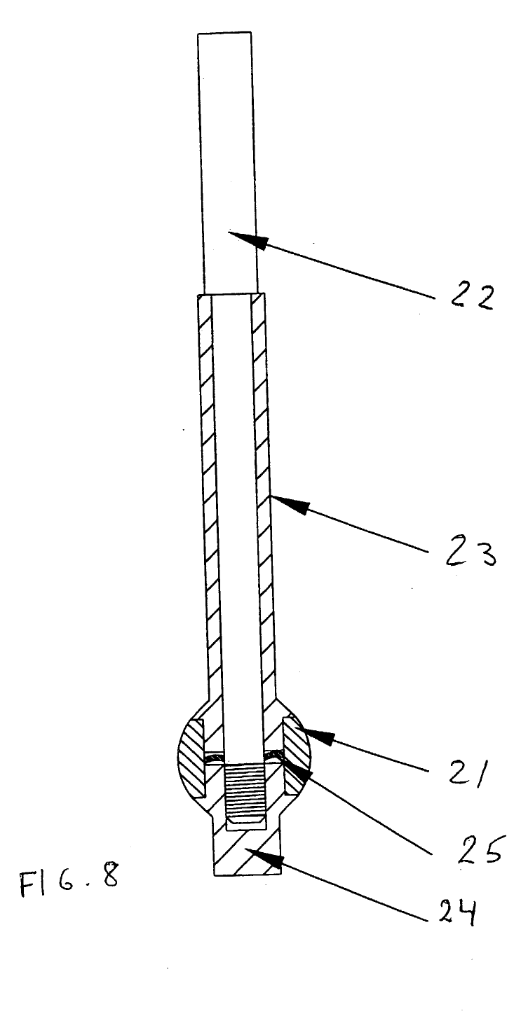

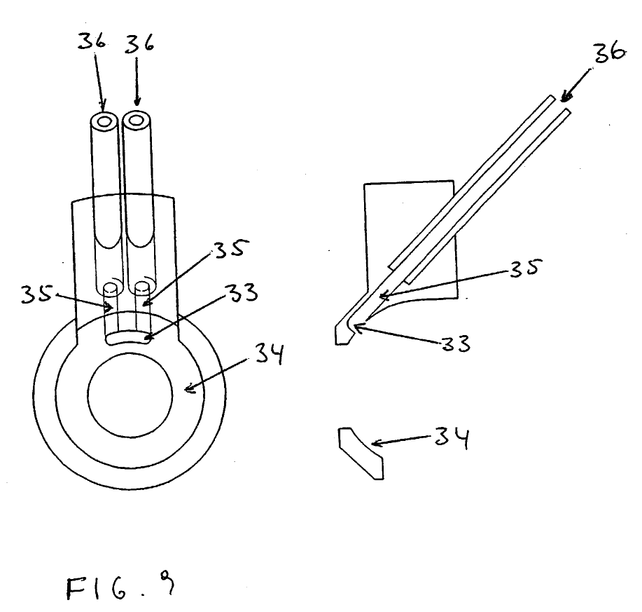

The moving member shown in FIGS. 1-3 is assumed to be made entirely of a noble metal or other metal covered with a noble metal. However, only the part of the surface of the moving member which gets exposed to the medium in the system to which the dosing unit is attached is required to be made of a conducting material suitable for electrode purpose. An alternative construction of a spherical moving member limiting the noble metal surface to the functional part of the surface is shown in FIG. 8. A platinum ring 21 in the shaped of a disk cut equatorially out of a sphere and having an axial bore is fixed to a steel shaft 22 by means of a tube 23 and a box nut 24 both made of hard, non-conducting polymer. Electric contact between the platinum ring and the steel shaft is established by a thin, flexible metal washer 25 inside the bore of the platinum ring.

The dosing unit in whatever embodiment may be functionally combined with two or more identical or different systems. A system may be a reservoir or a flow-through cell for liquid or gas, or it may be an apparatus which analyses, treats or produces something or serves in a scientific investigation or it may be a living organism.

As illustrated by the examples where the system is a mass spectrometer or an electrochemical cell, a large variety of possibilities exist where processes may be regulated by means of electric polarisation of the moving member of the dosing unit with respect to a liquid.

1. Dosing unit for liquid, comprising a reservoir and a moving member, said moving member being in close contact with a gasket arranged in an opening in the enclosure of said reservoir, said moving member being connected with drive means for moving it, whereby liquid sample from said reservoir adhered to the surface of said moving member is dragged past the gasket and made available to an attached system, characterized in that an electrode is provided in said reservoir so that an electric potential may be provided between said moving member and the liquid sample in said reservoir.

2. Dosing unit according to claim 1, characterized in that said moving member is a body of revolution.

3. Dosing unit according to claim 2, characterized in that said moving of said moving member is a rotation which is constant, intermittent or reciprocating.

4. Dosing unit according to any single one of the previous claims, characterised in that said gasket is provided with a flow-through channel for a sample stream.

5. Dosing unit according to any single one of the previous claims, characterised in that said moving member, or at least the surface of the moving member, is made of at least one from the group consisting of platinum, carbon, gold, iridium and palladium.

6. Dosing unit according to any single one of the previous claims, characterised in that said attached system comprises at least one from the group consisting of a mass spectrometer, an electrochemical cell, a sample cell for gas, and a living organism.

7. Dosing unit according to any single one of the preceding claims, characterised in that said attached system comprises a plurality of compartments containing liquid, gas, or vacuum.

8. Use of dosing unit according to any single one of the previous claims in at least one from the group consisting of chemical analysis, medical treatment, and production processes, including production of electricity.
